(19) United States
(12) Patent Application Publication
(10) Pub. No.: US 2026/0060327 A1
(43) Pub. Date: Mar. 5, 2026

(54) CONTROL SYSTEMS FOR ELECTRONIC CIGARETTES

(71) Applicant: Hyatt Alaraj, Orland Park, IL (US)

(72) Inventor: Hyatt Alaraj, Orland Park, IL (US)

(21) Appl. No.: 19/315,814

(22) Filed: Sep. 1, 2025

Related U.S. Application Data
(60) Provisional application No. 63/689,834, filed on Sep. 2, 2024.

(51) Int. Cl. A24F 40/53; A24F 40/485; A24F 40/51; A24F 40/57; A24F 40/60; A24F 40/65; A24F 47/00; G06F 21/31

(52) U.S. Cl. CPC A24F 40/53; A24F 40/485; A24F 40/51; A24F 40/57; A24F 40/60; A24F 40/65; A24F 47/00; G06F 21/31

(57) ABSTRACT

A control system for an electronic cigarette is disclosed for delivering controlled amount of nicotine and preventing underage smokers. The electronic cigarette is configured with a controller for controlling a plurality of components of the electronic cigarette. The controller is configured to activate the electronic cigarette, on receiving a user authentication. The controller is configured to monitor at least one parameter during at least one of activation of the electronic cigarette, and in usage of the electronic cigarette. Further, the controller is configured to control a deliverable amount of nicotine over a time interval, based on the monitored parameter to control smoking over time of a user.

### CROSS-REFERENCE TO RELATED APPLICATIONS

The present application claims the benefit to priority of U.S. Provisional Application No. 63/689,834, filed on Sep. 2, 2024, the content of which is hereby incorporated by reference in its entirety.

### TECHNICAL FIELD

The present disclosure relates generally to electronic cigarettes and, more particularly to a control system for electronic cigarettes for delivering controlled amounts of nicotine and to prevent underage smoking.

### BACKGROUND

Electronic cigarettes are a recently developed innovation that provides a convenient and accessible manner for users to inhale nicotine. An electronic cigarette (e.g., vape, e-cigarette) is powered by a battery that powers a heating element. The heating element vaporizes electronic cigarette liquid in the electronic cigarette that mixes with ambient air to create vapor, which is then inhaled into a smoker's lungs with further simulation of smoke being exhaled by the smoker.

The electronic cigarette liquid (e.g., vape juice, juice) in an electronic cigarette contains an active ingredient nicotine. Nicotine is a type of alkaloid having a low molecular weight. During smoking, nicotine along with other additives, enters the smoker's lungs and is rapidly absorbed. These vapors have been proven to be harmful to smokers. Further, it has been proven that passive smoking can be harmful to others in the vicinity of the smoker; known as second-hand smoke.

Further, due to the exponential increase of usage of electronic cigarettes, underage smoking continues to soar. Although control technologies for electronic cigarettes continue to be developed and electronic cigarette controllers may have some protecting functions, conventional electronic cigarettes are unable to limit a deliverable amount of nicotine over a period of time. Further, many conventional electronic cigarettes do not provide means for preventing underage smokers.

Accordingly, a control system for electronic cigarettes which overcomes the shortcomings of the prior art is highly desired.

### SUMMARY

Various details of the present disclosure are hereinafter summarized to provide a basic understanding of the technology. This summary is not an extensive overview of the disclosure and is neither intended to limit certain elements of the disclosure, nor to delineate the scope thereof. Rather, the primary purpose of this summary is to present some concepts of the disclosure in a simplified form.

According to an embodiment, an electronic cigarette is disclosed. The electronic cigarette comprises a controller, where the controller includes a programmed control chip. The controller is configured to activate the electronic cigarette, on receiving a user authentication. The controller is configured to monitor at least one parameter during at least one of activation of the electronic cigarette, and in usage of the electronic cigarette. Further, the controller is configured to control a deliverable amount of nicotine over a time interval, based on the monitored parameter to control smoking over time of a user.

According to an embodiment, a method for controlling nicotine consumption using a controller of the electronic cigarette is disclosed. The method includes activating, by the controller, the electronic cigarette, on receiving at least one user authentication. The method includes monitoring, by the controller, at least one parameter during at least one of activation of the electronic cigarette, and in usage of the electronic cigarette. Thereafter, the method includes controlling, by the controller, a deliverable amount of nicotine over a time interval, based on the monitored parameter to control smoking over time of a user.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The present disclosure will be better understood through the written description with reference to the accompanying drawing figures in which like reference numerals denote similar structure and refer to like elements throughout in which:

FIG. 1 is a schematic diagram of an electronic cigarette comprising a control system, according to some embodiments;

FIG. 2 is a schematic block diagram of a controller, according to some embodiments;

FIG. 3 depicts an example exploded view of the electronic cigarette, according to some embodiments;

FIG. 4 depicts an assembled view of the electronic cigarette, according to some embodiments;

FIG. 5 depicts an example alternate block representation of the controller, according to some embodiments;

FIG. 6 depicts a method for controlling nicotine consumption using the controller of the electronic cigarette, according to some embodiments; and

FIG. 7 is a schematic diagram of the electronic cigarette communicatively coupled to a smartphone and a cloud service.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a control system for electronic cigarettes for delivering controlled amount of nicotine over a period of time. Further, some embodiments of this disclosure generally relate to a control system for electronic cigarettes to prevent smoking by underage users.

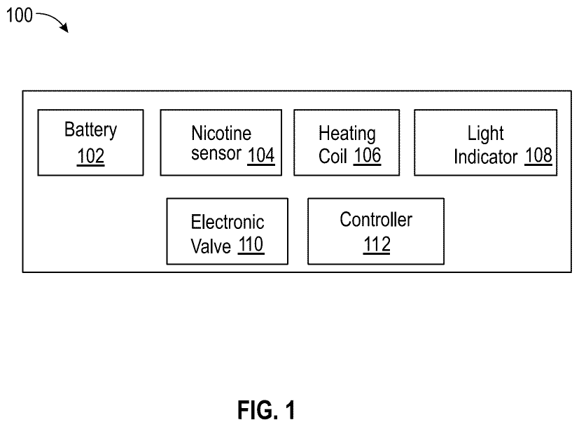

Referring to FIG. 1, a schematic diagram of an electronic cigarette 100 having a control system is shown, according to some embodiments. The electronic cigarette 100 may include a battery 102 for supplying power to a plurality of components of the electronic cigarette 100 such as a nicotine sensor 104, a heating coil 106, a light indicator 108, an electronic valve 110, and a controller 112. It should be noted that not all of these components are required to achieve the goals of the electronic cigarette 100. For example, some embodiments of the electronic cigarette 100 do not include the electronic valve 110. In some other embodiments, the electronic cigarette 100 does not include the controller 112. In some other embodiments, the electronic cigarette 100 does not include the nicotine sensor 104. In any of these embodiments, a single component (e.g., the electronic valve 110 and/or the controller 112) may facilitate and/or provide the functionality of a second component.

The battery 102 may either be integrated or removable from the electronic cigarette 100. The battery 102 is often activated by a button actuated by a user or is automatically activated, via a flow sensor, in response to the user inhaling the electronic cigarette 100. The user utilizes the electronic cigarette 100 over a period of time. The electronic cigarette 100 outputs an amount of nicotine vaporized during that period of time. The amount of nicotine that is vaporized may be based on various parameters including, but not limited to, a duration of the period of time, a chemical composition of the electronic cigarette liquid, a rate of heat exposed to the electronic cigarette liquid by the heating coil 106.

In an embodiment, the nicotine sensor 104 is configured to measure an amount of nicotine consumed by the user during the smoking period. The nicotine sensor 104 is configured to transfer the measured amount of nicotine to the controller 112 of the electronic cigarette 100. The nicotine sensor 104 may be any conventional sensor for detecting nicotine. For example, the nicotine sensor 104 may be a particulate sensor that detects the presence of small particles (e.g., nicotine, propylene glycol, vegetable glycerin) released during vaping. In another example, the nicotine sensor 104 may be a gas sensor that detects the presence of specific gasses (e.g., nicotine, propylene glycol, vegetable glycerin) released during vaping. In yet example, the nicotine sensor 104 may be a combination of a particulate sensor and a gas sensor that detects the presence of small particles and gasses released during vaping.

In some embodiments, an amount of nicotine vaporized may be a pre-programmed rate that is digitally input into the electronic cigarette 100. In these embodiments, a manufacturer of the electronic cigarette 100 may store the pre-programmed rate for an amount of nicotine in the electronic cigarette 100. Further, the amount of nicotine may consider other parameters of the electronic cigarette 100 (e.g., a power level of the electronic cigarette 100, the output of the heating coil 106). In these embodiments, the controller 112 for the electronic cigarette 100 calculates the amount of nicotine that is vaporized by the electronic cigarette 100 after considering the pre-programmed percentage of nicotine in the electronic cigarette liquid, a duration of time the electronic cigarette 100 has been activated, and a power output of the heating coil of the electronic cigarette 100 to calculate the amount of nicotine vaporized by the electronic cigarette 100.

In some embodiments, activation of the heating coil 106 is controlled by the controller 112. The heating coil 106 that vaporizes the electronic cigarette is typically made of a resistive wire wrapped around a wick. However, any convention heating element may be utilized. The heating coil 106 heats up due to the electric current supplied by the battery 102. The heat generated by the heating coil 106 causes the electronic cigarette liquid disposed in the electronic cigarette 100 (for example on the wick) to vaporize.

In some embodiments, the user of the electronic cigarette 100 can define a nicotine limit directly onto the electronic cigarette 100 or via an application (e.g., APP) in wireless communication with the electronic cigarette 100. The user's defined nicotine limit may be a tool for the user to reduce and/or quit their use of the electronic cigarette 100. The user can define an amount of nicotine per a period of time, a window of use, or any other parameter that may assist with the user to reduce electronic cigarette usage over time. For example, the user may define that they are limited to a 12 milligrams of nicotine per hour for each hour between 8 a.m.-10 p.m. In this example, once the electronic cigarette 100 has vaporized 12 milligrams of nicotine, the electronic cigarette 100 may lock the user from the electronic cigarette 100 until the remainder of the hour has expired. Once the hour has expired, the electronic cigarette 100 is now available by the user to resume use until they again vaporize 12 milligrams of nicotine. Further in this example, the electronic cigarette 100 may be unavailable for use between 10 p.m. to 8 a.m.

In some embodiments, the electronic cigarette 100 may generate a plan, in real-time, for aiding the user in quitting. In these embodiments, the electronic cigarette 100 and/or the application in wireless communication with the electronic cigarette 100 may determine a baseline amount of nicotine used by the user on a regular basis (e.g., hourly, daily, weekly) and may determine typical windows of times the user uses the electronic cigarette 100. The electronic cigarette 100 and/or the app may then generate a plan to facilitate for the user to quit over time.

In some embodiments, the light indicator 108 is controlled by the controller 112. In some embodiments, the light indicator 108 is configured to output a colored light (for example, green) to indicate to the user when smoking is below a pre-defined nicotine limit. The light indicator 108 may be further configured to indicate a second color (for example, yellow) when the amount of nicotine approaches the pre-defined nicotine limit (for example, when 10% away from the nicotine limit, when 20% away from the nicotine limit). The light indicator 108 is configured to indicate a third color (for example, red) to indicate to the user that the electronic cigarette 100 has reached the pre-defined nicotine limit. The light indicator 108 is electronically and/or communicatively coupled with the controller 112 so that the light indicator 108 may indicate excessive nicotine consumption to the user.

The controller 112 may include components to facilitate its functions, such as but not limited to, a central processing unit (CPU), a processor, a memory (e.g., RAM, ROM, SSD), and input/output capabilities. The controller 112 may control for the electronic cigarette 100 to be activated or to deactivate electronic cigarette 100. The controller 112 may be electronically and/or communicatively coupled to the heating coil 106. Further, the controller 112 may be electronically and/or communicatively coupled to the nicotine sensor 104. In some embodiments, the nicotine sensor 104 provides a signal to the controller 112 indicating an amount of nicotine output by the electronic device 100. The controller 112 may store that amount of nicotine and compare it to a pre-determined nicotine threshold. If the pre-determined nicotine threshold has not been met, the controller 112 allows for the electronic cigarette 100 to continue to be activated. In some embodiments, the controller 112 may send a signal to the heating coil 106 after each time the user uses the electronic cigarette 100 to activate. In other words, the heating coil 106 is in an “OFF” mode after each usage and is only turned to an “ON” mode after receiving a signal from the controller 112. In other embodiments, the heating coil 106 remains in an “ON” mode and is only turned to an “OFF” mode when instructed by the controller 112. If the pre-determined nicotine threshold has been met, the controller 112 may prevent for the electronic cigarette 100 from continuing to be activated. Similarly to above, the controller 112 may send a signal to the heating coil 106 to be turned to the “OFF” mode or does not send the signal to the heating coil 106 so that it remains in the “OFF” mode.

The pre-determined nicotine threshold may be, in some embodiments, a user specified input. The user may specify a maximum amount (e.g., dosage, volume) of nicotine per a specified interval. For example, the user may define 25 mg of nicotine that may be vaporized in an hour. Over time the user may lower the amount to 15 mg of nicotine, and so on. In this way, the user may track and, accordingly, decrease their nicotine intake over time. In other words, the user can control the amount of nicotine they intake so that they may eventually quit and/or control consumption. In some embodiments, the user may specify the pre-determined nicotine threshold directly into the electronic cigarette 100 via buttons and/or a touch screen. In some embodiments, the user may specify the pre-determined nicotine threshold using an application (e.g., such as a smartphone application for a smartphone) that is communicatively coupled to the electronic cigarette 100. In some embodiments, a second user (e.g., a different user than the primary user) may have control of the electronic cigarette 100.

In some embodiments, metrics indicating usage of the electronic cigarette 100 (e.g., via the number of puffs/amount of nicotine) may be sent to the smartphone application. The smartphone application may then present the usage of the electronic cigarette 100 in a graphical form in the user interface (e.g., usage of the electronic cigarette over a period of time). In some embodiments, these electronic cigarette 100 may be utilized to create a user profile and/or baseline of nicotine usage and windows of activity. These metrics may be utilized to generate a smoking reduction plan for the user by the electronic cigarette 100 and/or the application.

In some embodiments, the electronic cigarette 100 further includes the electronic valve 110. The electronic valve 110 may receive a signal from and is controlled by the controller 112. The electronic valve 110 may be electrically coupled and/or communicatively coupled to the electronic valve 110. In these embodiments, the electronic valve 110 is configured to allow air flow into and/or out of the electronic cigarette 100 when prompted by the controller 112. The electronic valve 110 is further configured to reduce and/or stop incoming air flow to the electronic cigarette 100 or to the mouthpiece to prevent vapor from forming when prompted by the controller 112. In these embodiments, the controller 112 does not send a signal to the heating coil 106, but rather prevents and or allows the electronic valve 110 from providing airflow to and/or out of the electronic cigarette 100. In doing so, vapor cannot be created by the electronic cigarette 100.

In some embodiments, the controller 112 includes a programmable control chip (PCC). In some embodiments, the electronic device further includes the PCC and the PCC is electronically and/or communicably coupled with the controller 112. The PCC may control any of the functions described above as it pertains to the controller 112.

In some embodiments, using the same approaches discussed above, the controller 112 may prevent underage smoking by preventing the heating coil 106 from activating and/or preventing the electronic valve 110 from receiving air flow into the electronic cigarette 100 and/or outputting vapor out of the electronic cigarette 100.

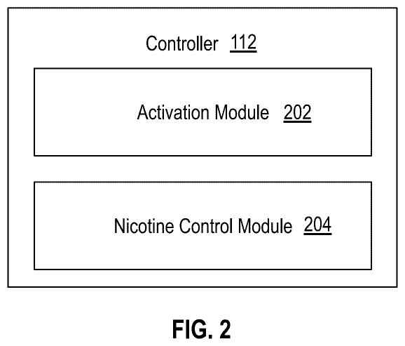

Referring to FIG. 2, a schematic block diagram of the controller 112 is disclosed, according to some embodiments. The controller 112 may further comprise an activation module 202 and/or a nicotine control module 204. In some embodiments including the PCC, the activation module 202 and the nicotine control module 204 are disposed into the PCC. In some embodiments, the activation module 202 and the nicotine control module 204 are disposed in another component of the electronic device 100. In these embodiments, the electronic device 100 includes communication capabilities to receive and/or send signals from another device (e.g., a smart phone, a server).

In these embodiments, when the electronic device 100 includes the activation module 202, the activation module 202 is configured to receive a signal from the other device. The signal indicates to the electronic cigarette 100 via the activation module 100 to be activated. The signal may be indicative that the user has authenticated their age with the other device. In other words, the user may authenticate their age with a device (e.g., their smart phone, with a vendor, with a 3^{rd} party entity). The electronic cigarette 100 then receives a signal from the smart phone or a server that authorizes the use of the electronic cigarette 100. In embodiments using the server, the server may receive a signal from the user's smart phone to authenticate the user's age. In other embodiments, the server may communicate only with a group of authorized users (e.g., electronic cigarette vendors) to authenticate a user's age at a time of purchase of the electronic cigarette 100. The server may then send a signal to the electronic cigarette 100. In some embodiments, only a single signal is sent to the electronic cigarette 100 to “activate” the electronic cigarette 100. In some embodiments, a regularly occurring signal over a period (e.g., daily, weekly) is required by the electronic device 100 to continue the “activation” of the electronic cigarette 100.

In some embodiments, the electronic cigarette 100 communicates with the smart phone wirelessly with methods including, but not limited to, WiFi, Bluetooth®, cellular networks (e.g., 3G, 4G, 5G), Near-field Communication (NFC®), Apple® AirDrop®, Android® Nearby Share, or any other wireless communication technology. In some embodiments, the electronic cigarette 100 communicates with the server wirelessly with methods including, but not limited to, WiFi, cellular networks (e.g., 3G, 4G, 5G), or any other wireless communication technology.

In some embodiments, when the electronic device 100 includes the nicotine control module 204, the nicotine control module 204 is configured to receive a signal from the nicotine sensor 104 and monitor at least one parameter during at least one of activation of the electronic cigarette 100, and in usage of the electronic cigarette 100. The parameter can include, but not limited to an amount of times and/or a duration of an activation (e.g., by pressing a button, by inhaling) of the electronic device 100 by the user, a number of activations over a period of time output of the electronic cigarette 100, or an amount of nicotine consumed by the user (via the nicotine sensor 104). The nicotine control module 204 is configured to control a deliverable amount of nicotine over a time interval, based on the monitored parameter to control smoking over time of the user. As described above, the electronic cigarette 100, via the nicotine control module 204, may allow or stop the electronic device 100 to operate when a pre-determine nicotine threshold has been met. In other embodiments, the electronic cigarette 100, via the nicotine control module 204, may limit an output of the electronic device 100 after the pre-determined nicotine threshold has been met. In these embodiments, electronic device 100 via the controller 112 and/or the electronic valve 110 may limit a duration of each activation by the user, limit the amount of air flow input into the electronic cigarette 100 and/or limit the amount of air flow output from the electronic cigarette 100, and/or limit a heating capacity of the heating coil 106, thereby limiting the rate of electronic cigarette fluid being burnt.

In some embodiments, the user needs to press a button to use the electronic cigarette 100. A number of button presses can be counted using a counting mechanism (for example, counts the number of activations). In some embodiments, the button cannot be actuated (after X amount of puffs per a time interval). Only after a pre-determined period of time expires does the electronic cigarette allow for the button to be actuated. Actuation of the button may be controlled via any conventional approach (e.g., a mechanical block, an electronic block).

In some embodiments, the nicotine control module 204 is configured to count the button press (e.g., button placed on the electronic cigarette 100 for activating the electronic cigarette 100) by the user for counting a number of activations of the electronic cigarette 100, after activating the electronic cigarette 100. Each actuation of the button may be correlated to a value of nicotine. Once the pre-determined nicotine threshold has been met, the button may no longer be actuatable. In some embodiments, the amount of nicotine that is output by the electronic cigarette 100 may be calculated using machine learning (ML) and/or artificial intelligence (AI) techniques. In other words, ML and/or AI may receive inputs (e.g., a duration of the period of time, a chemical composition of the electronic cigarette liquid, a rate of heat exposed to the electronic cigarette liquid by the heating coil 106) and output a predicted amount of nicotine output by the electronic cigarette 100 and/or inhaled by the user.

In some embodiments, the nicotine control module 204 is configured to receive a measured amount of nicotine consumed by the user via the nicotine sensor 104 of the electronic cigarette 100. The nicotine control module 204 is configured to control the delivered amount of nicotine. When the measured amount of nicotine consumed by the user exceeds a pre-defined limit, the electronic cigarette 100 may be deactivated until a pre-determined time period has expired.

In some embodiments, the nicotine control module 204 is configured to control the deliverable amount of nicotine by controlling the activation of the heating coil 106, based on the monitored parameter (e.g., such as by a number of button presses by the user, a number of puffs per a time interval of the electronic cigarette 100, an amount of nicotine consumed by the user). In these embodiments, the heating coil 106 may limit the amount of heat delivered to the nicotine fluid or may not be activated at all.

In some embodiments, the nicotine control module 204 is configured to control the deliverable amount of nicotine by controlling the electronic valve 110 to control an incoming air flow into the electronic cigarette 100 and/or outputting vapor out of the electronic cigarette 100.

In some embodiments, the controller 112 is configured to indicate excessive nicotine consumption to the light indicator 108 of the electronic cigarette 100. The controller 112 is configured to send a signal to the light indicator 108 to output a first color (e.g., green) indicating the user to smoke when smoking is below the pre-defined limit. The controller 112 is configured to send a signal the light indicator 108 to indicate a second color (e.g., yellow) when the user is approaching (e.g., within 10%, within 20%) the pre-defined limit. The controller 112 is configured to send a signal to the light indicator 108 to indicate a third color (e.g., red) to indicate to the user to that the electronic device 100 has reached the pre-defined limit. In these embodiments, the controller 112 may indicate to the user when a time interval for the pre-determined limit has been reset by sending a signal to the light indicator 108. In some embodiments, the light indicator 108 may alert the user by flashing a color (e.g., green) a number of times.

In some embodiments, the controller 112 may cause a circuit switch within the electronic cigarette 100 to open to limit/control nicotine consumption of the user. In doing so, the circuitry is placed in an open-state. In the open-state, the heating coil 106 or the battery 102 are not electronically coupled thereby not allowing for the circuit to be closed. In some embodiments, when the pre-determined threshold has been met, the controller 112 prevents the user from using the electronic cigarette 100 by not sending a signal to the heating coil 106 and/or battery 102.

In some embodiments, operations of the nicotine control for the electronic cigarette 100 can be performed via a screen on the electronic cigarette 100. The screen may or may not be password protected to allow a third party to control. For example, the user and/or a third party may set a pre-determined nicotine threshold by inputting the parameters into the electronic cigarette 100. In some embodiments, the operations of the nicotine control for the electronic cigarette 100 are performed via an application for a smartphone (e.g., such as smartphone 702 in FIG. 7) that is communicatively coupled to the electronic cigarette 100. In this way, the user and/or a third party may set the pre-determined nicotine threshold by inputting the parameters, for the electronic cigarette 100, into the smartphone application. The smartphone application may be password protected to facilitate for only a third-party to control the electronic cigarette 100. In embodiments, once the parameters have been input (e.g., X amount of nicotine/number of puffs per hour) the electronic cigarette 100 may be locked permanently. In doing so, the pre-determined nicotine threshold cannot be overridden by the user, for example, in a state of nicotine withdrawal.

In one embodiment, the user can manually pair the electronic cigarette 100 to a smart phone via Bluetooth or Near Field Communication (NFC). In some embodiments, a smartphone (e.g., such as smartphone 702 in FIG. 7) can automatically detect and pair in a scenario where the electronic cigarette 100 is within a proximity of the smartphone over a period of time.

In some embodiments, using any of the mechanisms described in greater detail above, the electronic cigarette 100 may be configured such that it only may be activated after identifying a user's age.

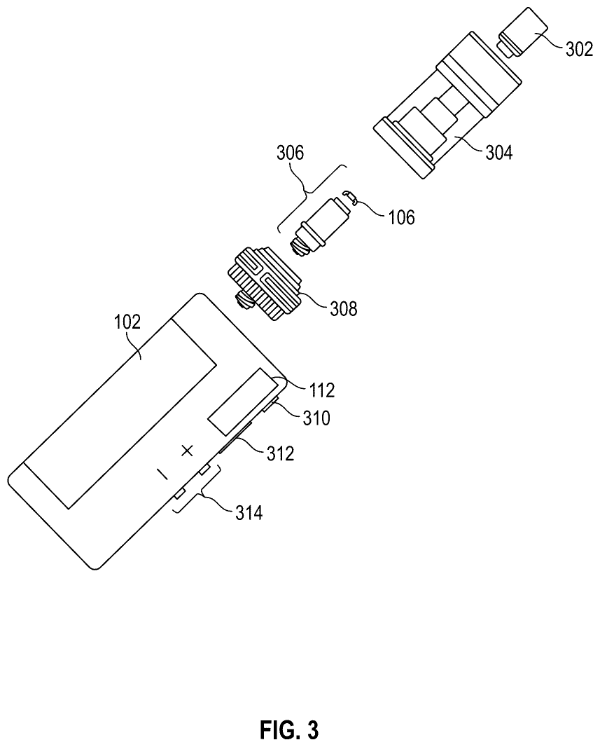

FIG. 3 depicts an exploded view of the electronic cigarette 100, according to some embodiments. The electronic cigarette 100 is depicted with a mouthpiece 302. A tank 304 holds a nicotine solution where the flavored solution of nicotine dissolved in vegetable glycerin or propylene glycol. A heating element 306 that changes the nicotine solution into an aerosol that the user inhales. The heating element 306 is equipped with a heating coil 106. An airflow control means 308 is used to increase air intake and increase aerosol production. Further, the electronic cigarette 100 is depicted with the battery 102, a power button 310, the controller 112, an LED screen 312, and a power adjusting means 314 for increasing coil temperature in the heating element and increase aerosol production.

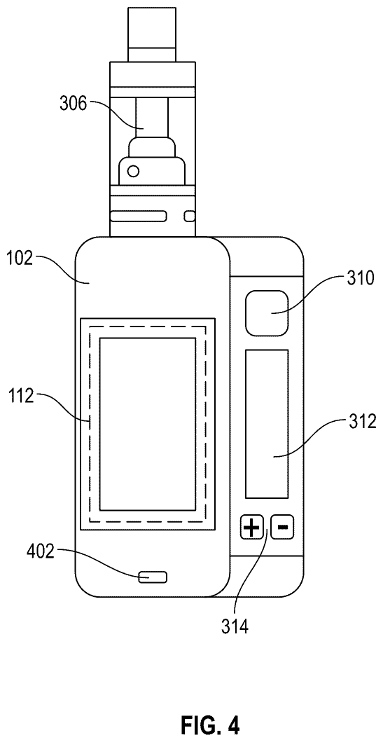

FIG. 4 depicts an assembled view of the electronic cigarette 100, according to some embodiments. The assembled view of the electronic cigarette 100 further depicts a charging port 402 for charging the battery 102.

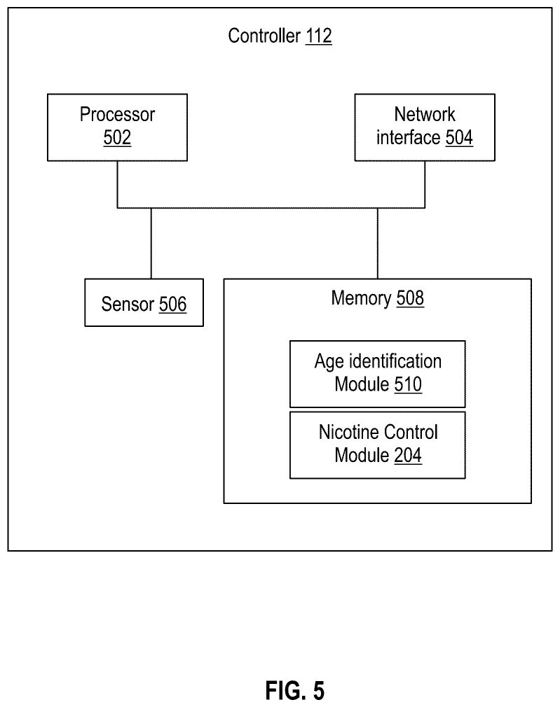

FIG. 5 depicts an example block representation of the controller 112, according to some embodiments. The controller 112 comprises a processor 502, a network interface 504, a sensor 506, and a memory 508.

The processor 502 is configured to execute the instruction stored in the memory 508. The network interface 504 is configured to enable data exchange between components of the electronic cigarette 100 and the controller 112 components. The sensor 506 collects measured amount of nicotine data from the nicotine sensor 104 of the electronic cigarette 100. The memory 508 further comprises an age identification module 510, and a nicotine control module 204. The components of the controller 112 may be electronically and/or communicatively coupled to each other. For example, the memory 508 and its sub-components (e.g., the age identification module 510, the nicotine control module 204), may be stored locally on the electronic cigarette 100. In some embodiments, these components are stored on a cloud and/or the user's smartphone application.

The age identification module 510 is configured to collect a user's age to facilitate user authentication and to activate the electronic cigarette 100. This module is designed to prevent usage of the electronic cigarette 100 by underage smokers. The age identification module 510 may be controlled by a manufacture of the electronic cigarette 100, a government entity, or another third party. Referring briefly to FIG. 7, for example, a user may submit their identification (e.g., ID) to an application on a smartphone 702 for review. In some embodiments, the identification is sent to a server 704 where a third party (e.g., manufacturer, government entity, any third party), can review the identification. In some embodiments, the identification is reviewed locally using the smartphone 702. In either embodiment, after successfully proving that the user of the smartphone 702 is of an age allowed to use an electronic cigarette 100, the smartphone 702 sends a signal to the age identification module 510 of the electronic cigarette 100. Using the mechanics stated detailed herein, the age identification module 510 may now allow for the usage of the electronic cigarette 100.

The nicotine control module 204 is configured to control a deliverable amount of nicotine over a time interval during usage, based on the monitored at least one parameter to control smoking over time of the user. The parameter can include but not limited to a button press by the user, a number of puffs per a time interval of the electronic cigarette 100, and an amount of nicotine consumed by the user. The memory 508 is configured to store data of the electronic cigarette 100 such as the user authentication details, sensor 506 details, and so on.

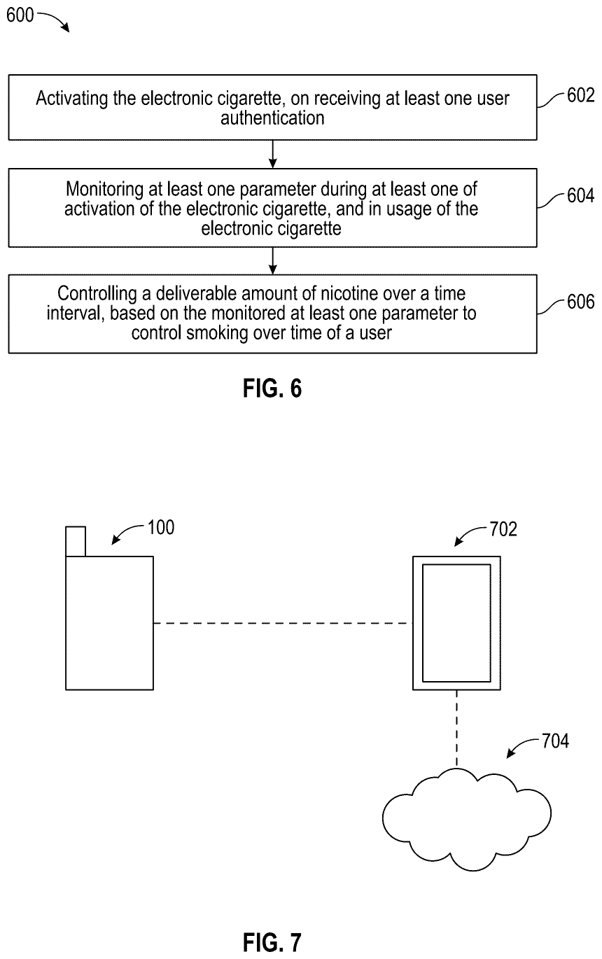

Referring to FIG. 6, a schematic block diagram of a method 600 for controlling nicotine consumption using the controller 112 of the electronic cigarette 100 is disclosed, according to some embodiments. The method 600 includes activating, by the controller 112, the electronic cigarette 100, as depicted in step 602, on receiving at least one user authentication. Further, the method 600 includes monitoring, by the controller 112, at least one parameter, as depicted in step 604, during at least one of activation of the electronic cigarette 100, and in usage of the electronic cigarette 100. Further, the method 600 includes controlling, by the controller 112, a deliverable amount of nicotine over a time interval, as depicted in step 606, based on the monitored parameter to control smoking over time of the user.

In some embodiments, using the mechanisms explained in greater detail above, the electronic cigarette 100 may intermittently prevent any usage of the electronic cigarette 100. For example, if the electronic cigarette 100 is no longer connected to a smartphone (e.g., such as smartphone 702), the electronic cigarette 100 may deactivate until it is again in communication with the smartphone. As the user identity is associated with a particular smartphone, this capability prevents third parties from permanently “unlocking” electronic cigarettes for underage users. In some embodiments, after a period of time (e.g., an hour), the electronic cigarette 100 may automatically deactivate. To reactive the electronic cigarette 100, the electronic cigarette 100 may require communicating with the same smartphone to ensure the same user has access to the electronic cigarette 100.

FIG. 7 is a schematic diagram of the electronic cigarette 100 communicatively coupled to a smartphone 702. The smartphone 702 may be any phone having internet capabilities and having access to smartphone applications. The smartphone 702 may be communicatively coupled to the electronic cigarette 100 using, but not limited, WiFi, Bluetooth®, cellular networks (e.g., 3G, 4G, 5G), Near-field Communication (NFC®), Apple® AirDrop®, Android® Nearby Share, or any other wireless communication technology. In some embodiments, the electronic cigarette 100 communicates with the server wirelessly with methods including, but not limited to, WiFi, cellular networks (e.g., 3G, 4G, 5G), or any other wireless communication technology.

The cloud 704 may be any service or structure (e.g., a server) that may be communicatively coupled to the smartphone 702. In this way, the electronic cigarette 100 may send data to and/or receive data from the cloud 704 via the smartphone 702. For example, a third party may control the usage of the electronic cigarette 100 by using a second smart phone communicatively coupled to the cloud 704. The cloud 704 may send this instruction to the electronic cigarette 100 via the smartphone 702. In doing so, the third party may monitor and/or control the usage of the electronic cigarette 100.

In embodiments, any of the electronic cigarette 100, the smartphone 702, and/or the cloud 704 may store the memory of the electronic cigarette 100 (e.g., such as memory 508, age-identification module 510, nicotine control module 204).

The terminology used herein is for the purpose of describing particular embodiments only and is not intended to be limiting of the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such.

While the disclosure has described several embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for carrying out this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. An electronic cigarette, comprising:
a controller comprising a programmed control chip, wherein said controller is configured to:
activate said electronic cigarette, on receiving at least one user authentication;
monitor at least one parameter during at least one of activation of said electronic cigarette, and in usage of said electronic cigarette; and
control a deliverable amount of nicotine over a time interval, based on said monitored at least one parameter to control smoking over time of a user.

2. The electronic cigarette of claim 1, wherein said at least one user authentication comprises of entering an identity information of said user into said electronic cigarette using an electronic device, wherein said identity information comprises a user's age.

3. The electronic cigarette of claim 1, wherein said electronic cigarette is activated by said controller when said electronic cigarette is in proximity to said electronic device to prevent unlocking of said electronic cigarette for minors.

4. The electronic cigarette of claim 1, wherein said at least one parameter comprises at least one of a button press by said user, a number of puffs per a time interval of said electronic cigarette, and an amount of nicotine consumed by said user.

5. The electronic cigarette of claim 4, wherein said controller is configured to count said button press by said user for counting a number of activations of said electronic cigarette, after activating said electronic cigarette.

6. The electronic cigarette of claim 4, wherein said controller is configured to receive a measured amount of nicotine consumed by said user, from a nicotine sensor of said electronic cigarette.

7. The electronic cigarette of claim 1, wherein said controller is configured to control said deliverable amount of nicotine, by performing at least one of:
controlling activation of a heating coil;
skipping activation of said electronic cigarette; and
controlling an electronic valve to control an incoming air flow into said electronic cigarette.

8. The electronic cigarette of claim 1, wherein said controller is configured to indicate excessive nicotine consumption on a light indicator of said electronic cigarette.

9. The electronic cigarette of claim 8, wherein said controller is configured to control said light indicator to indicate a green color allowing said user to smoke when smoking is below a pre-defined limit, wherein said controller is configured to control said light indicator to indicate a yellow color when smoking approaches close to said pre-defined limit, wherein said controller is configured to control said light indicator to indicate a red color to not allow said user to smoke when smoking reaches said pre-defined limit.

10. The electronic cigarette of claim 1, wherein said controller is operated by said electronic device via an application, wherein said application is overridden by said user.

11. A method for controlling nicotine consumption using a controller of an electronic cigarette, comprising:
activating, by a controller, said electronic cigarette, on receiving at least one user authentication;
monitoring, by said controller, at least one parameter during at least one of activation of said electronic cigarette, and in usage of said electronic cigarette; and
controlling, by said controller, a deliverable amount of nicotine over a time interval, based on said monitored at least one parameter to control smoking over time of a user.

12. The method of claim 11, wherein said at least one user authentication comprises of entering an identity information of said user into said electronic cigarette using an electronic device, wherein said identity information comprises a user's age.

13. The method of claim 11, wherein said electronic cigarette is activated by said controller when said electronic cigarette is in proximity to said electronic device to prevent unlocking of said electronic cigarette for minors.

14. The method of claim 11, wherein said at least one parameter comprises at least one of a button press by said user, a number of puffs per a time interval of said electronic cigarette, and an amount of nicotine consumed by said user.

15. The method of claim 14, wherein said method performs at least one of:
counting, by said controller, said button press by said user for counting a number of activations of said electronic cigarette, after activating said electronic cigarette; and
receiving, by said controller, a measured amount of nicotine consumed by said user, from a nicotine sensor of said electronic cigarette.

16. The method of claim 11, wherein said method of controlling said deliverable amount of nicotine, by performing at least one of:
controlling, by said controller, activation of a heating coil;
skipping, by said controller, activation of said electronic cigarette; and
controlling, by said controller, an electronic valve to control an incoming air flow into said electronic cigarette.

17. The method of claim 11, wherein said method comprises indicating, by said controller, excessive nicotine consumption on a light indicator of said electronic cigarette.

18. The method of claim 17, wherein said method performs at least one of:
controlling, by said controller, said light indicator to indicate a green color allowing said user to smoke when smoking is below a pre-defined limit;
controlling, by said controller, said light indicator to indicate a yellow color when smoking approaches close to said pre-defined limit; and
controlling, by said controller, said light indicator to indicate a red color to not allow said user to smoke when smoking reaches said pre-defined limit.

19. The method of claim 11, wherein said controller is operated by said electronic device via an application, wherein said application is overridden by said user.
